(19) United States
(12) Patent Application Publication
(10) Pub. No.: US 2026/0292364 A1
(43) Pub. Date: Sep. 24, 2026

(54) PHOTOELECTRIC CONVERSION DEVICE

(71) Applicant: CANON KABUSHIKI KAISHA, Tokyo (JP)

(72) Inventor: TOMOYA SASAGO, Kanagawa (JP)

(21) Appl. No.: 19/564,244

(22) Filed: Mar. 12, 2026

(30) Foreign Application Priority Data
Mar. 18, 2025 (JP) 2025-043653

(51) Int. Cl. H04N 25/773; H04N 25/709; H04N 25/76; H04N 25/79

(52) U.S. Cl. CPC H04N 25/773; H04N 25/709; H04N 25/7795; H04N 25/79

(57) ABSTRACT

A photoelectric conversion device includes a first pixel including a first avalanche photodiode and a charge circuit configured to apply a first reverse bias voltage equal to or higher than a breakdown voltage to the first avalanche photodiode, wherein the first pixel is configured to output a signal by avalanche multiplication of the first avalanche photodiode; and a second pixel including a second avalanche photodiode and a voltage control circuit configured to apply a second reverse bias voltage lower than the breakdown voltage to the second avalanche photodiode, wherein the second pixel is configured not to output a signal by avalanche multiplication of the second avalanche photodiode.

### BACKGROUND

### Field of the Technology

The present disclosure relates to a photoelectric conversion device.

### DESCRIPTION OF THE RELATED ART

A photoelectric conversion device in which a plurality of pixels each including an avalanche photodiode (APD) are arranged is known. When a photon is incident on the APD, avalanche multiplication occurs. A single photon level can be detected by a detection signal corresponding to avalanche multiplication.

Japanese Patent Laid-Open No. 2023-61883 describes a photodetector including an active pixel that outputs a detection signal by an APD and a dummy pixel that does not output a detection signal by an APD. The dummy pixel and the active pixel have the same pixel circuit, and the APD of the dummy pixel is charged with a current in the same manner as the APD of the active pixel.

However, in Japanese Patent Laid-Open No. 2023-61883, there is room for improvement in the current in the dummy pixel.

### SUMMARY

Therefore, the present disclosure is directed to provide a photoelectric conversion device capable of suppressing a current in a pixel that does not output a signal by an APD, such as a dummy pixel.

According to one aspect of the present specification, there is provided a photoelectric conversion device that includes a first pixel including a first avalanche photodiode and a charge circuit configured to apply a first reverse bias voltage equal to or higher than a breakdown voltage to the first avalanche photodiode, wherein the first pixel is configured to output a signal by avalanche multiplication of the first avalanche photodiode; and a second pixel including a second avalanche photodiode and a voltage control circuit configured to apply a second reverse bias voltage lower than the breakdown voltage to the second avalanche photodiode, wherein the second pixel is configured not to output a signal by avalanche multiplication of the second avalanche photodiode, wherein the voltage control circuit is configured to control the second reverse bias voltage applied to a cathode of the second avalanche photodiode based on a voltage of the cathode.

Features of the present disclosure will become apparent from the following description of embodiments with reference to the attached drawings. The following description of embodiments is described by way of example.

### BRIEF DESCRIPTION OF THE DRAWINGS

FIG. 1 is an exploded perspective view of a stacked photoelectric conversion device according to a first embodiment.

FIG. 2 is a plan view of a sensor substrate according to the first embodiment.

FIG. 3 is a plan view of a circuit substrate according to the first embodiment.

FIG. 4 is a plan view of a pixel region according to the first embodiment.

FIG. 5 is a block diagram of an active pixel according to the first embodiment.

FIG. 6 is a diagram illustrating a relationship between avalanche multiplication and a pulse signal according to the first embodiment.

FIG. 7 is a block diagram of an active pixel according to the first embodiment.

FIG. 8 is a block diagram of a dummy pixel according to the first embodiment.

FIG. 9A is a diagram illustrating an operation of an APD according to a comparative example.

FIG. 9B is a diagram illustrating operation of the APD according to the first embodiment.

FIG. 10 is a block diagram of a dummy pixel according to a second embodiment.

FIG. 11 is a block diagram of a dummy pixel according to a third embodiment.

FIG. 12 is a block diagram of a dummy pixel according to a fourth embodiment.

FIG. 13 is a block diagram of a dummy pixel according to a fifth embodiment.

FIG. 14 is a block diagram of a dummy pixel according to a sixth embodiment.

FIG. 15 is a block diagram of an active pixel and a test pixel according to a seventh embodiment.

FIG. 16 is a block diagram of an active pixel, a dummy pixel, and an inactive pixel according to an eighth embodiment.

FIG. 17 is a block diagram of an active pixel and a dummy pixel according to a ninth embodiment.

FIGS. 18A, 18B, 18C, and 18D are schematic diagrams illustrating a configuration of a substrate according to the ninth embodiment.

FIG. 19 is a plan view of a circuit substrate according to a tenth embodiment.

FIG. 20 is a block diagram of an equipment according to an eleventh embodiment.

FIGS. 21A and 21B are block diagrams of an equipment according to a twelfth embodiment.

### DESCRIPTION OF THE EMBODIMENTS

### First Embodiment

The following embodiments are intended to embody the technical idea of the present disclosure, and do not limit the present disclosure. The sizes and positional relationships of members illustrated in the drawings may be exaggerated for clarity of description. In the following description, the same components are denoted by the same reference numerals, and the description thereof may be omitted.

Hereinafter, embodiments of the present disclosure will be described in detail with reference to the drawings. In the following description, terms (for example, "up", "down", "right", "left" and other terms including those words) indicating a specific direction or position are used as necessary. The use of these terms is to facilitate understanding of the embodiments with reference to the drawings, and the technical scope of the present disclosure is not limited by the meanings of these terms.

In the present specification, a plan view refers to a view from a direction perpendicular to a light incident surface of a semiconductor layer. When the light incident surface of the semiconductor layer is a rough surface as viewed microscopically, a plan view is defined with reference to the light incident surface of the semiconductor layer as viewed macroscopically.

In the following description, the anode of an APD (avalanche photodiode) is set to a fixed voltage, and a signal is extracted from the cathode side. Therefore, the semiconductor region of the first conductivity type having charges of the same polarity as the signal charge as majority carriers is an N-type semiconductor region, and the semiconductor region of the second conductivity type having charges of the polarity different from the signal charge as majority carriers is a P-type semiconductor region. The present disclosure is also applicable to a case where the cathode of the APD is set to a fixed voltage and a signal is extracted from the anode side. In this case, the semiconductor region of the first conductivity type having charges of the same polarity as the signal charges as majority carriers is a P-type semiconductor region, and the semiconductor region of the second conductivity type having charges of the polarity different from the signal charges as majority carriers is an N-type semiconductor region. Although a case where one node of the APD is set to a fixed voltage will be described below, the voltages of both nodes may vary.

In the following embodiments, connections between elements of a circuit may be described. In this case, even when another element is interposed between the elements of interest, the elements of interest are treated as being connected to each other unless otherwise specified. For example, an element A is connected to one node of a capacitor C having a plurality of nodes, and an element B is connected to the other node. Even in such a case, the element A and the element B are regarded as being connected to each other unless otherwise specified.

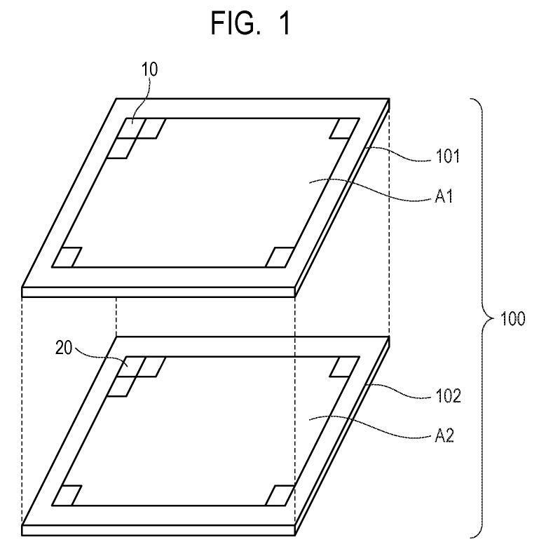

FIG. 1 is an exploded perspective view of a stacked photoelectric conversion device 100 according to the present embodiment. In the photoelectric conversion device 100, two semiconductor substrates, a sensor substrate 101 and a circuit substrate 102, are stacked and electrically connected. The sensor substrate 101 has a pixel region A1, and the circuit substrate 102 has a circuit region A2. In a state in which the sensor substrate 101 and the circuit substrate 102 are stacked, the photoelectric conversion device 100 includes a plurality of pixels. Each pixel includes a photoelectric conversion unit 10 and a signal processing unit 20. The photoelectric conversion unit 10 is provided in the pixel region A1, and the signal processing unit 20 is provided in the circuit region A2.

The sensor substrate 101 includes a first semiconductor layer including the photoelectric conversion unit 10 and a first interconnect structure. The circuit substrate 102 includes a second semiconductor layer having circuits such as the signal processing unit 20 and a second interconnect structure. In the photoelectric conversion device 100, the second semiconductor layer, the second interconnect structure, the first interconnect structure, and the first semiconductor layer are stacked in this order. The photoelectric conversion device 100 is a back-illuminated type, in which light is incident from the second surface of the first semiconductor layer, and the circuit substrate 102 is arranged on the first surface of the first semiconductor layer.

The sensor substrate 101 and the circuit substrate 102 are described as diced chips but are not limited to chips. For example, each substrate may be a wafer. In addition, each substrate may be diced after being stacked in a wafer state, or each chip may be stacked and bonded after being converted into a chip from a wafer state.

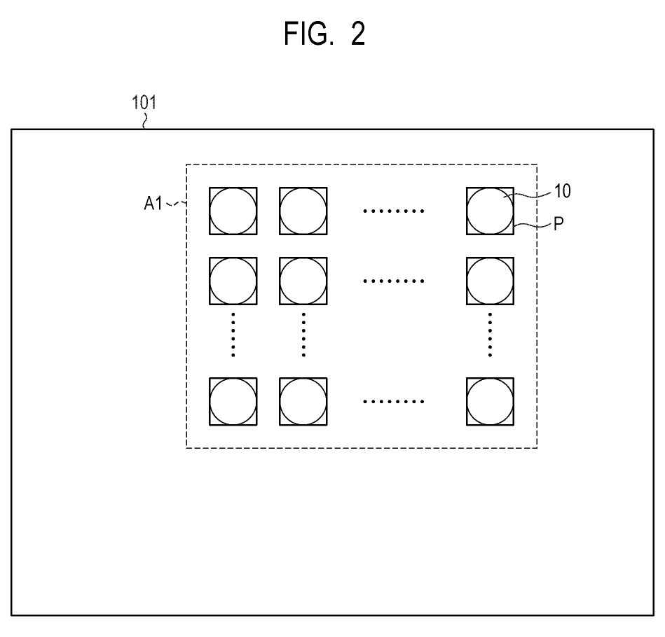

FIG. 2 is a plan view of the sensor substrate 101 according to the present embodiment. In the pixel region A1 of the sensor substrate 101, the photoelectric conversion units 10 of the pixels P are arranged in a two-dimensional array in plan view. Note that the arrangement of the photoelectric conversion units 10 in the pixel region A1 may be one-dimensionally arranged.

The pixel P is typically a pixel for forming an image but does not necessarily have to form an image when used for TOF (Time of Flight) measurement. That is, the pixel may be for measuring the time and the amount of light reaching the pixel.

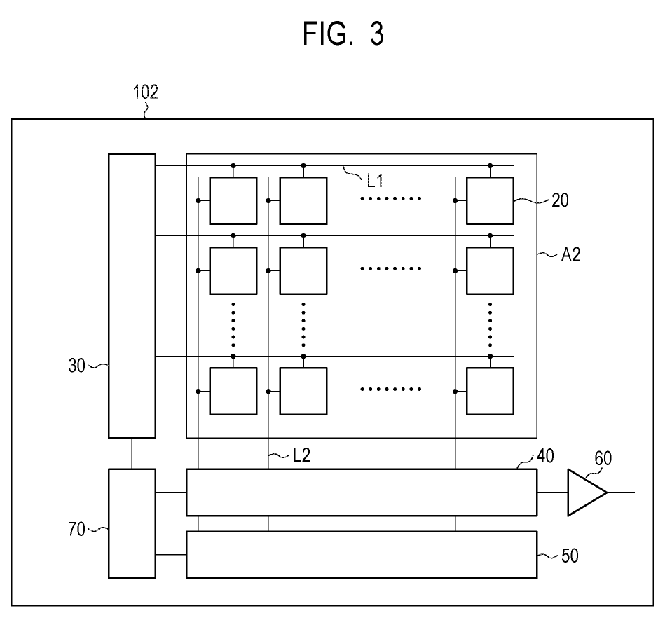

FIG. 3 is a plan view of the circuit substrate 102 according to the present embodiment. In the circuit region A2 of the circuit substrate 102, the signal processing units 20 of the pixels P are arranged in a two-dimensional array in plan view. The pixel region A1 and the circuit region A2 overlap each other in a plan view, and the photoelectric conversion unit 10 and the signal processing unit 20 correspond to each other in each pixel P.

In each row of the pixel array of the circuit substrate 102, a control line L1 extends in a first direction (lateral direction in FIG. 3). The control line L1 is connected respectively to the signal processing units 20 of the pixels P arranged in the first direction and forms a signal line common to the signal processing units 20. The signal processing units 20 arranged in the same row are controlled by the same control line L1. Each of the control lines L1 may include a plurality of signal lines for supplying a plurality of types of control signals to the signal processing unit 20.

In each column of the pixel array of the circuit substrate 102, a data line L2 extends in a second direction (vertical direction in FIG. 3) intersecting the first direction. The data line L2 is connected to the signal processing units 20 of the pixels P arranged in the second direction, respectively, and form signal lines common to the signal processing units 20. Each of the data lines L2 may include a plurality of signal lines for transferring a digital signal of a plurality of bits output from the signal processing unit 20 in parallel on a bit-by-bit basis.

The circuit substrate 102 includes a vertical scanning circuit 30, a readout circuit 40, a horizontal scanning circuit 50, an output circuit 60, and a control circuit 70. These circuits are arranged in a region around the circuit region A2.

The vertical scanning circuit 30 receives a control signal from the control circuit 70, generates a control signal for driving the signal processing unit 20, and supplies the control signal to the signal processing unit 20 via the control line L1. The vertical scanning circuit 30 may include a logic circuit such as a shift register and an address decoder. The vertical scanning circuit 30 sequentially scans the pixels P in the circuit substrate 102 in units of rows and sequentially causes the pixels P to output pixel signals to the readout circuit 40 via the data lines L2. Thus, an image of one frame is acquired.

The readout circuit 40 includes a plurality of holding units (not illustrated) provided corresponding to each column of the pixel array of the circuit substrate 102. The readout circuit 40 holds the pixel signals of the pixels P of the respective columns, which are output from the signal processing units 20 in units of rows via the data lines L2, in the holding units of the corresponding columns.

The horizontal scanning circuit 50 receives a control signal from the control circuit 70, generates a control signal for reading out a pixel signal from the holding unit of each column of the readout circuit 40, and supplies the control signal to the readout circuit 40. The horizontal scanning circuit 50 may include a logic circuit such as a shift register and an address decoder. The horizontal scanning circuit 50 sequentially scans the holding units of each column of the readout circuit 40 and sequentially causes the holding units to output the pixel signals to the output circuit 60.

The output circuit 60 includes an external interface circuit, and outputs the pixel signals output from the readout circuit 40 to the outside of the photoelectric conversion device 100. The external interface circuit included in the output circuit 60 is not particularly limited. A SerDes (SERializer/DESerializer) transmission circuit is applicable to the external interface circuit. As the SerDes transmission circuit, for example, an LVDS (Low Voltage Differential Signaling) circuit, an SLVS (Scalable Low Voltage Signaling) circuit, or the like can be applied.

The control circuit 70 generates a control signal for controlling operations and timings of the vertical scanning circuit 30, the readout circuit 40, and the horizontal scanning circuit 50, and supplies the control signal to each functional block. At least a part of the control signals for controlling the operations and timings of the vertical scanning circuit 30, the readout circuit 40, and the horizontal scanning circuit 50 may be supplied from the outside of the photoelectric conversion device 100.

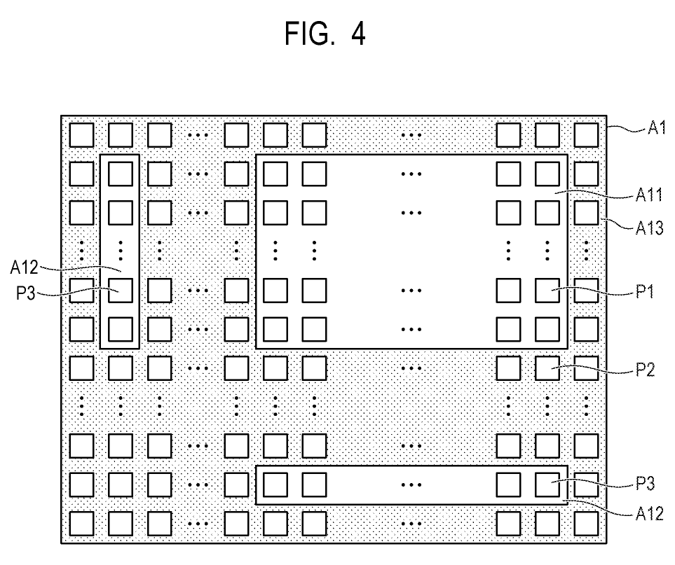

FIG. 4 is a plan view of the pixel region A1. The plurality of pixels P include an active pixel (first pixel) P1, a dummy pixel (second pixel) P2, and an OB (Optical Black) pixel P3. Each of the active pixel P1, the dummy pixel P2, and the OB pixel P3 includes a photoelectric conversion unit 10 and a signal processing unit 20.

The active pixel P1 detects a photon in the photoelectric conversion unit 10, and outputs a photon detection signal to the outside of the active pixel P1. The active pixel P1 is typically a pixel for forming an image.

The dummy pixel P2 detects a photon in the photoelectric conversion unit 10, but does not output a photon detection signal to the outside of the dummy pixel P2. The dummy pixel P2 is used, for example, for uniformizing a circuit pattern in a manufacturing process.

The photoelectric conversion unit 10 of the OB pixel P3 is optically shielded, and the OB pixel P3 outputs a photon detection signal in the shielded state to the outside of the OB pixel P3. The photon detection signal of the OB pixel P3 is used for black level correction.

The photoelectric conversion units 10 of the active pixel P1, the dummy pixel P2, and the OB pixel P3 are arranged in the pixel region A1. The pixel region A1 includes a first region A11, a plurality of second regions A12, and a third region A13.

The photoelectric conversion unit 10 of the active pixel P1 is arranged in the first region A11. The first region A11 is formed in a rectangular shape and is provided slightly above and to the right of the center of the pixel region A1. In the first region A11, the photoelectric conversion units 10 are arranged in a two-dimensional array in plan view. The number of rows and the number of columns of the photoelectric conversion units 10 included in the first region A11 are not particularly limited.

The photoelectric conversion units 10 of the OB pixels P3 are arranged in the plurality of second regions A12. Each of the second regions A12 is formed in a rectangular shape smaller than the first region A11 and is arranged at an interval from the first region A11. For example, the second regions A12 are arranged at two positions: one in a direction perpendicular to the first region A11 and another in a direction horizontal to the first region A11. In the second region A12, the photoelectric conversion units 10 of the OB pixels P3 are arranged in a one-dimensional array in plan view. The number of rows and the number of columns of the photoelectric conversion units 10 included in the second region A12 are not particularly limited.

The photoelectric conversion unit 10 of the dummy pixel P2 is arranged in the third region A13. The third region A13 is a region other than the first region A11 and the second region A12 in the pixel region A1. For example, the third region A13 is provided in the outer peripheral portion of the pixel region A1 which is easily affected by the edge effect. Accordingly, the circuit patterns of the active pixel P1 and the OB pixel P3 can be made uniform. The third region A13 is provided between the first region A11 and the second region A12. Accordingly, interference between the active pixel P1 and the OB pixel P3 can be suppressed. In the third region A13, the photoelectric conversion units 10 of the dummy pixels P2 are arranged in a two-dimensional array in plan view. The number of rows and the number of columns of the photoelectric conversion units 10 included in the third region A13 are not particularly limited.

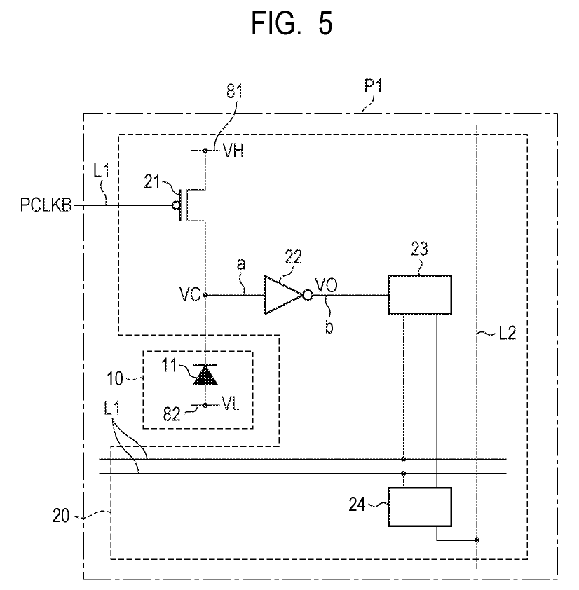

FIG. 5 is a block diagram of the active pixel P1 according to the present embodiment. In the active pixel P1, the photoelectric conversion unit 10 includes an APD 11, and the signal processing unit (first signal processing circuit) 20 includes a quench element (charge circuit) 21, a waveform shaping circuit 22, a counter circuit 23, and a selection circuit 24.

The anode of the APD 11 is connected to a power supply interconnect 82 that supplies a voltage VL (for example, -30V). The cathode of the APD 11 is connected to one terminal of the quench element 21. A connection node between the APD 11 and the quench element 21 is an output node of the photoelectric conversion unit 10. The other terminal of the quench element 21 is connected to a power supply interconnect 81 that supplies a voltage VH (for example, 1.1V) higher than the voltage VL. The voltage VL and the voltage VH are set to be a reverse bias voltage (first reverse bias voltage) that causes the APD 11 to induce avalanche multiplication. Here, a negative high voltage is supplied as the voltage VL, and a positive voltage that is approximately equal to the power supply voltage is supplied as the voltage VH.

By making it possible to apply a reverse bias voltage between the anode and the cathode of the APD 11, carriers generated by light incident on the APD 11 cause avalanche multiplication, and an avalanche current is generated. The operation modes in a state where a reverse bias voltage is applied to the APD 11 include a Geiger mode and a linear mode. The Geiger mode is an operation mode in which the voltage applied between the anode and the cathode is set to a voltage higher than the breakdown voltage Vbd of the APD 11. That is, the reverse bias voltage in the Geiger mode is the sum of the breakdown voltage Vbd and the predetermined excess voltage Vex. The linear mode is an operation mode in which the reverse bias voltage is set to a voltage close to or lower than the breakdown voltage Vbd of the APD 11. The APD 11 operated in the Geiger mode is called SPAD (Single-Photon Avalanche Diode). In the present embodiment, it is assumed that the APD 11 operates in the Geiger mode. The reverse bias voltage of the APD 11 is not limited to the total voltage of the breakdown voltage Vbd and the excess voltage Vex and may be equal to or higher than the breakdown voltage.

The quench element 21 converts a change in the avalanche current generated in the APD 11 into a voltage signal. In addition, the quench element 21 functions as a load circuit (quench circuit) at the time of signal multiplication by avalanche multiplication and reduces the reverse bias voltage applied to the APD 11 to suppress avalanche multiplication. The operation in which the quench element 21 suppresses avalanche multiplication is called a quench operation. The quench element 21 returns the voltage applied to the APD 11 to a reverse bias voltage capable of avalanche multiplication by causing a current corresponding to the voltage drop due to the quench operation to flow to the APD 11. The operation of the quench element 21 to return the reverse bias voltage is called a charging operation, and the current supplied to the APD 11 in the charge operation is called a charge current.

In the present embodiment, the quench element 21 is constituted by a PMOS transistor, and the clock signal PCLKB is input to the gate of the PMOS transistor from the vertical scanning circuit 30. The clock signal PCLKB may be input periodically. The on/off of the PMOS transistor is controlled by the clock signal PCLKB, and the electrical connection between the power supply interconnect 81 and the cathode of the APD 11 is switched. When the PMOS transistor is turned on, a charge current is supplied from the power supply interconnect 81 to the cathode of the APD 11. When the PMOS transistor is turned off, the supply of the charge current from the power supply interconnect 81 to the cathode of the APD 11 is stopped. Note that the quench element 21 may be formed of a resistive element.

The waveform shaping circuit 22 has an input node (node a) to which an output signal of the photoelectric conversion unit 10 is input and an output node (node b). The waveform shaping circuit 22 converts an analog signal output from the photoelectric conversion unit 10 into a pulse signal. The waveform shaping circuit 22 includes a NOT circuit (inverter circuit). The output node of the waveform shaping circuit 22 is connected to the counter circuit 23.

The counter circuit 23 includes an input node to which an output signal of the waveform shaping circuit 22 is input, an input node connected to the control line L1, and an output node. The counter circuit 23 counts the pulse signal superimposed on the output signal from the waveform shaping circuit 22 and holds the count value. The control signal supplied from the vertical scanning circuit 30 to the counter circuit 23 via the control line L1 may include an enable signal for controlling the count period (exposure period) of the pulse signal, a reset signal for resetting the count value held by the counter circuit 23, and the like. The output node of the counter circuit 23 is connected to the data line L2 via the selection circuit 24.

The selection circuit 24 switches the electrical connection between the counter circuit 23 and the data line L2. The selection circuit 24 switches the connection between the counter circuit 23 and the data line L2 in accordance with a control signal supplied from the vertical scanning circuit 30 via the control line L1. The selection circuit 24 may include a buffer circuit (not illustrated) for outputting a signal.

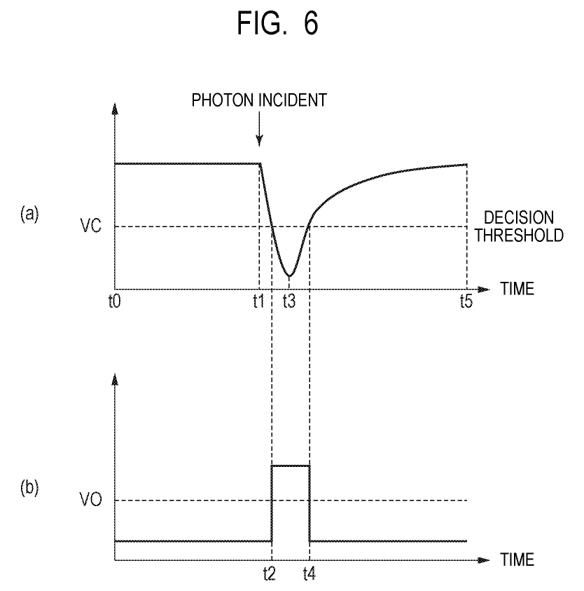

FIG. 6 is a diagram illustrating a relationship between avalanche multiplication and a pulse signal according to the present embodiment. At time t0, a reverse bias voltage corresponding to "voltage VH-VL" is applied to the APD 11. Although the reverse bias voltage is supplied to the APD 11, carriers serving as a seed of avalanche multiplication do not exist in a state where a photon is not incident on the APD 11. Therefore, avalanche multiplication does not occur in the APD 11, and no current flows through the APD 11.

At time t1, when a photon is incident on the APD 11, an electron-hole pair is generated by photoelectric conversion. Avalanche multiplication occurs using these carriers as seed carriers, and an avalanche current flows through the APD 11. When the avalanche current flows, the voltage VC of the node a of the waveform shaping circuit 22 starts to drop.

When the drop amount of the voltage VC increases and the avalanche multiplication stops at time t3, the voltage VC does not drop any more. After the avalanche multiplication is stopped, the PMOS transistor of the quench element 21 is turned on, a charge current that compensates for the voltage drop flows from the power supply interconnect 81 to the cathode of the APD 11, and the voltage VC gradually increases.

At time t5, the voltage VC is settled to a voltage capable of avalanche multiplication. After the voltage is settled, the PMOS transistor of the quench element 21 is turned off, and the node to which the cathode of the APD 11 is connected becomes floating.

The waveform shaping circuit 22 binarizes the signal input from the node a according to a predetermined decision threshold and outputs the signal from the node b. Specifically, the waveform shaping circuit 22 outputs a low-level signal from the node b when the voltage of the node a exceeds the decision threshold, and outputs a high-level signal from the node b when the voltage of the node a is less than or equal to the decision threshold. For example, as illustrated in FIG. 6, it is assumed that the voltage of the node a is equal to or lower than the decision threshold in the period from the time t2 to the time t4. In this case, the signal level at the node b becomes high. In addition, the low level is set in the period from the time t0 to the time t2 and the period from the time t4 to the time t5.

In this way, the analog signal input from the node a is waveform-shaped into a digital signal by the waveform shaping circuit 22. A pulse signal is output from the waveform shaping circuit 22 in response to the incidence of a photon on the APD 11.

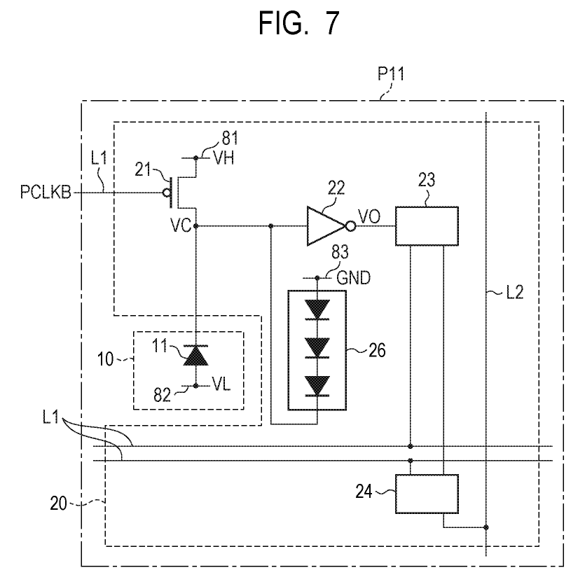

FIG. 7 is a block diagram of the active pixel P11 according to the present embodiment. The active pixel P11 is different from the active pixel P1 of FIG. 5 in that it includes a voltage control circuit 26. A description of the same configuration as that of the active pixel P1 will be omitted as appropriate.

The voltage control circuit 26 includes a plurality of diodes, for example, a first diode, a second diode, and a third diode. The first diode, the second diode, and the third diode are connected in series in this order, the anode of the third diode is connected to the power supply interconnect 83, and the cathode of the first diode is connected to the cathode of the APD 11. The voltage of the power supply interconnect 83 is between the voltage VL (-30V) and the voltage VH (1.1V), and is, for example, the same voltage (0V) as GND (ground). The voltage of the power supply interconnect 83 may be the same voltage (1.1V) as the voltage VH.

The voltage control circuit 26 controls the reverse bias voltage (second reverse bias voltage) applied to the cathode of the APD 11 in accordance with the cathode voltage VC of the APD 11. The voltage control circuit 26 controls the reverse bias voltage so that the cathode voltage VC does not become equal to or lower than a predetermined voltage. For example, when the cathode voltage VC falls to a predetermined voltage, that is, a voltage lower than the GND voltage by the threshold voltage of the diode, the voltage control circuit 26 causes a current to flow from the power supply interconnect 83 to the cathode of the APD 11. When a current flows through the cathode, the cathode voltage VC stops decreasing at a predetermined voltage, and the cathode voltage VC can be prevented from decreasing beyond the predetermined voltage. Accordingly, it is possible to suppress the cathode voltage VC from exceeding the withstand voltage of the PMOS transistor of the quench element 21.

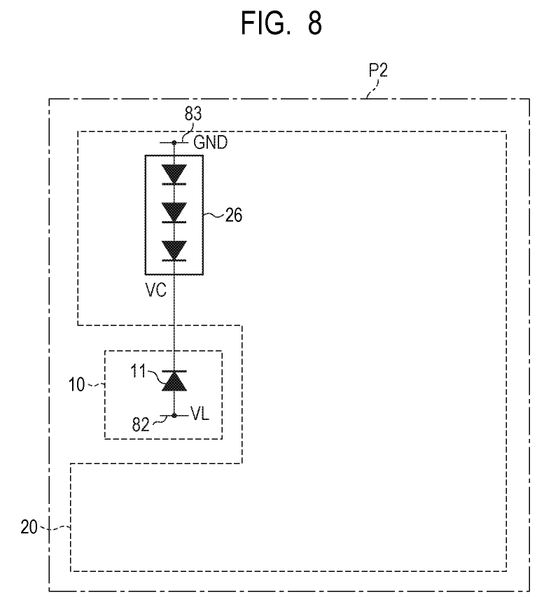

FIG. 8 is a block diagram of the dummy pixel P2 according to the present embodiment. Like the active pixel P11, the dummy pixel P2 includes the photoelectric conversion unit 10 and the voltage control circuit 26. On the other hand, unlike the active pixel P11, the dummy pixel P2 does not include the quench element 21, the waveform shaping circuit 22, the counter circuit 23, and the selection circuit 24.

The photoelectric conversion unit 10 includes an APD 11, and the anode of the APD 11 is connected to the power supply interconnect 82 that supplies the voltage VL (for example, -30V). The cathode of the APD 11 is connected to the voltage control circuit 26.

The voltage control circuit 26 is configured similarly to the voltage control circuit 26 of FIG. 7, and includes a first diode, a second diode, and a third diode connected in series. The anode of the third diode is connected to the power supply interconnect 83 (GND), and the cathode of the first diode is connected to the cathode of the APD 11. The voltage control circuit 26 controls the reverse bias voltage applied to the APD 11 in accordance with the cathode voltage VC of the APD 11. Since the voltage control circuit 26 includes a plurality of diodes, it is easy to appropriately set the voltage drop due to the threshold voltages of the diodes and to set the cathode voltage VC to a desired value. The voltage control circuit 26 may include one diode.

Since the dummy pixel P2 does not have the quench element 21, the cathode of the APD 11 is not charged by the current from the power supply interconnect 81 like the active pixel P11. Accordingly, the charge current in the dummy pixel P2 can be suppressed. In addition, in the dummy pixel P2, a reverse bias voltage corresponding to a voltage difference between the voltage VL of the power supply interconnect 82 and the voltage GND of the power supply interconnect 83 is applied to the APD 11. The reverse bias voltage (voltage GND-voltage VL) of the dummy pixel P2 is lower than the breakdown voltage Vbd of the APD 11. As a result, avalanche multiplication does not occur in the APD 11 of the dummy pixel P2, and the current of the APD 11 of the dummy pixel P2 can be suppressed.

When a photon is incident on the APD 11 of the dummy pixel P2, the cathode voltage VC decreases due to the current of the APD 11. When the cathode voltage VC falls to a predetermined voltage, the voltage control circuit 26 causes a current to flow from the power supply interconnect 83 to the cathode of the APD 11. It is possible to suppress a decrease in the cathode voltage VC beyond a predetermined voltage due to a current flowing to the cathode. Accordingly, it is possible to suppress the cathode voltage VC of the APD 11 from exceeding the withstand voltage of the APD 11.

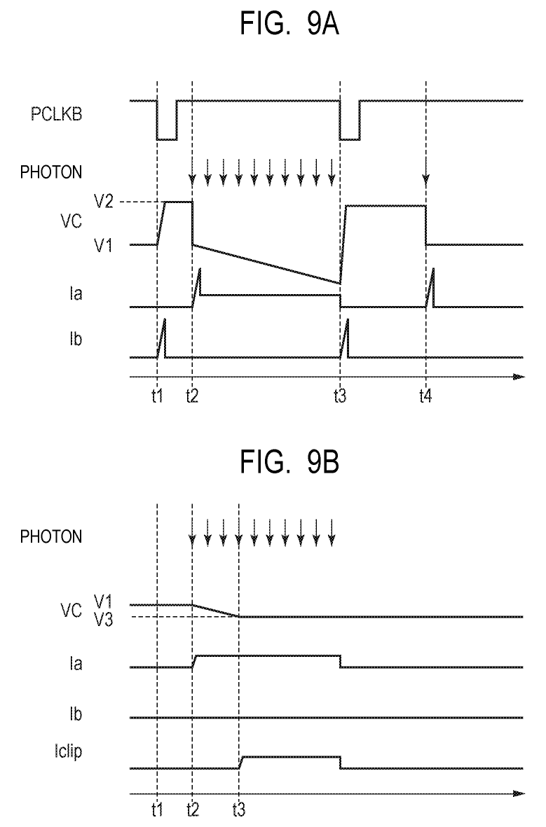

FIG. 9A is a diagram illustrating an operation of a dummy pixel according to a comparative example. Here, it is assumed that the dummy pixel of the comparative example is configured in the same manner as the active pixel P1 of FIG. 5. FIG. 9A illustrates a clock signal PCLKB for controlling the quench element 21, photons incident on the APD 11, a cathode voltage VC of the APD 11, a current Ia generated in the APD 11, and a charge current Ib.

At time t1, when the clock signal PCLKB becomes a low level, the PMOS transistor of the quench element 21 is turned on. When the PMOS transistor is turned on, the charge current Ib flows from the power supply interconnect 81 to the cathode of the APD 11, and the cathode voltage VC of the APD 11 increases from the voltage V1 to the voltage V2. When the voltage VC increases to the voltage V2, a reverse bias voltage (voltage VH-voltage VL) is applied to the APD 11. Here, the reverse bias voltage is a voltage obtained by adding the excess voltage Vex to the breakdown voltage Vbd, and the APD 11 enters a state capable of avalanche multiplication in the Geiger mode. When the clock signal PCLKB becomes a high level, the PMOS transistor of the quench element 21 is turned off, and the cathode of the APD 11 becomes a floating state.

When a photon is incident on the APD 11 at time t2, avalanche multiplication occurs, a current Ia flows through the APD 11, and the cathode voltage VC decreases from the voltage V2 to the voltage V1. Here, the voltage V1 is lower than the voltage V2 by the excess voltage Vex, and the reverse bias voltage of the APD 11 is equal to or lower than the breakdown voltage Vbd.

After time t2, photons are further incident on the APD 11. Here, since a reverse bias voltage lower than the breakdown voltage Vbd is applied to the APD 11, avalanche multiplication in the Geiger mode does not occur. The APD 11 operates in a linear mode, an electron-hole pair is generated by incidence of a photon, and a current Ia smaller than an avalanche current flows through the APD 11. When the current Ia flows, the cathode voltage VC of the APD 11 becomes lower than the voltage V1, and the voltage VC continues to further decrease according to the incidence of photons.

At time t3, the PMOS transistor of the quench element 21 is turned on, the charge current Ib flows from the power supply interconnect 81 to the cathode of the APD 11, and the cathode voltage VC of the APD 11 increases to the voltage V2. When the voltage VC increases to the voltage V2, a reverse bias voltage (voltage VH-voltage VL) in the Geiger mode is applied to the APD 11.

When a photon is incident on the APD 11 at time t4, avalanche multiplication occurs, a current Ia flows through the APD 11, and the cathode voltage VC decreases from the voltage V2 to the voltage V1.

As described above, in the dummy pixel of the comparative example, the charge current Ib is supplied to the cathode of the APD 11, and when the photon is incident on the APD 11, the avalanche current flows. This avalanche current may become noise. When photons are continuously incident on the APD 11, a current smaller than the avalanche current continuously flows, the cathode voltage VC continuously decreases, and there is a possibility that the cathode voltage VC continues to decrease, exceeding the withstand voltage of the transistor of the quench element 21.

FIG. 9B is a diagram illustrating an operation of the dummy pixel P2 according to the present embodiment. FIG. 9B illustrates photons incident on the APD 11, a cathode voltage VC of the APD 11, a current Ia generated in the APD 11, a charge current Ib, and a clip current Iclip.

At time t1, a reverse bias voltage lower than the breakdown voltage Vbd is applied to the APD 11, and the cathode voltage VC of the APD 11 is the voltage V1.

When a photon is incident on the APD 11 at time t2, avalanche multiplication in the Geiger mode does not occur, but electron-hole pairs are generated, and a current Ia smaller than the avalanche current in FIG. 9A flows through the APD 11.

When a photon is further incident on the APD 11 after the time t2, the current Ia continuously flows because the reverse bias voltage lower than the breakdown voltage Vbd is applied to the APD 11. When the current Ia continuously flows, the cathode voltage VC of the APD 11 continues to decrease from the voltage V1.

At time t3, when the cathode voltage VC decreases to the voltage V3, the current Iclip starts to flow from the voltage control circuit 26 to the cathode of the APD 11. When the current Iclip flows, the cathode voltage VC stops decreasing at the voltage V3. Here, the voltage V3 is a voltage lower than the voltage GND by the threshold voltage of the voltage control circuit 26. It is possible to suppress the cathode voltage VC from dropping beyond the voltage V3, and thus it is possible to suppress the cathode voltage VC of the APD 11 from exceeding the withstand voltage of the APD 11. Here, the current flowing from the voltage control circuit 26 to the APD 11 is limited to the current Iclip.

As described above, according to the photoelectric conversion device 100 of the present embodiment, since the current in the APD 11 can be suppressed in the dummy pixel P2, noise can be suppressed. In addition, it is possible to prevent the cathode voltage VC of the APD 11 from falling beyond the withstand voltage of the PMOS transistor of the quench element 21 or the APD 11.

### Second Embodiment

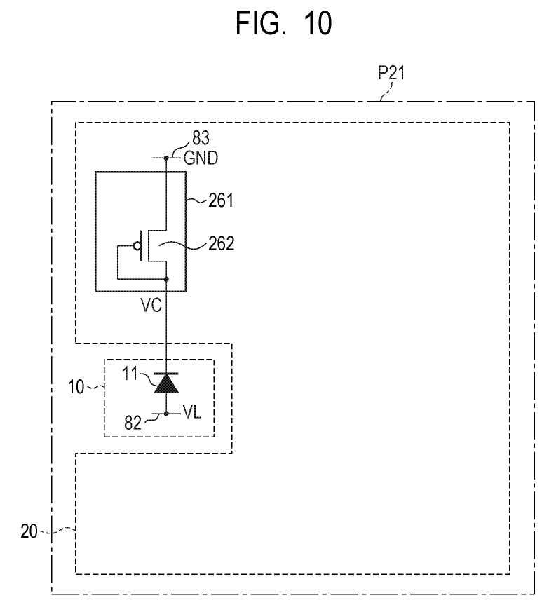

FIG. 10 is a block diagram of the dummy pixel P21 according to the present embodiment. In the present embodiment, the same components as those in the first embodiment are denoted by the same reference numerals, and detailed description thereof is omitted. The dummy pixel P21 includes a voltage control circuit 261 and the same photoelectric conversion unit 10 as that of the active pixel P1.

The voltage control circuit 261 includes a PMOS transistor 262. In the PMOS transistor 262, the source (first main node) is connected to the power supply interconnect 83, and the drain (second main node) is connected to the cathode of the APD 11. The drain is connected to the gate (control node) of the PMOS transistor 262.

When a photon is incident on the APD 11, the cathode voltage VC decreases due to the current of the APD 11. When the cathode voltage VC falls to a predetermined voltage, that is, the threshold voltage of the PMOS transistor 262, the PMOS transistor 262 is turned on, and a current flows from the power supply interconnect 83 to the cathode of the APD 11. It is possible to suppress a decrease in the cathode voltage VC beyond a predetermined voltage due to a current flowing to the cathode. Further, in the present embodiment, since the voltage control circuit 261 is constituted by one PMOS transistor, it is possible to reduce the area of the pixel.

### Third Embodiment

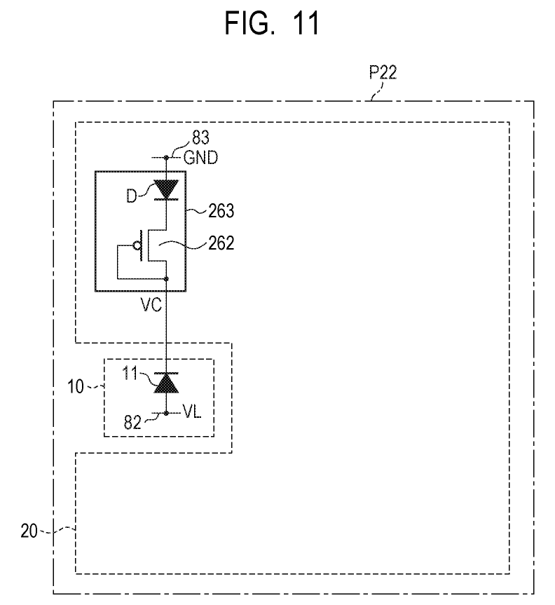

FIG. 11 is a block diagram of a dummy pixel P22 according to the present embodiment. The dummy pixel P22 has a voltage control circuit 263 and the same photoelectric conversion unit 10 as that of the active pixel P1.

The voltage control circuit 263 includes a diode D and a PMOS transistor 262. The PMOS transistor 262 and the diode D are connected in series between the power supply interconnect 83 and the cathode of the APD 11. That is, the anode of the diode D is connected to the power supply interconnect 83, and the cathode of the diode D is connected to the source of the PMOS transistor 262. The drain of the PMOS transistor 262 is connected to the cathode of the APD 11 and the gate of the PMOS transistor 262.

When a photon is incident on the APD 11, the cathode voltage VC decreases due to the current of the APD 11. When the cathode voltage VC falls to a predetermined voltage, the PMOS transistor 262 is turned on. When the PMOS transistor 262 is turned on, a forward bias voltage is applied to the diode D, and a current flows from the power supply interconnect 83 to the cathode of the APD 11. It is possible to suppress a decrease in the cathode voltage VC beyond a predetermined voltage due to a current flowing to the cathode.

In general, leakage current of a MOS transistor is larger than leakage current of a diode. Therefore, as compared with the configuration in which only the PMOS transistor 262 is provided as in the second embodiment, when the PMOS transistor and the diode D are used in combination, the leakage current flowing from the cathode side of the APD 11 to the power supply interconnect 83 side can be suppressed.

### Fourth Embodiment

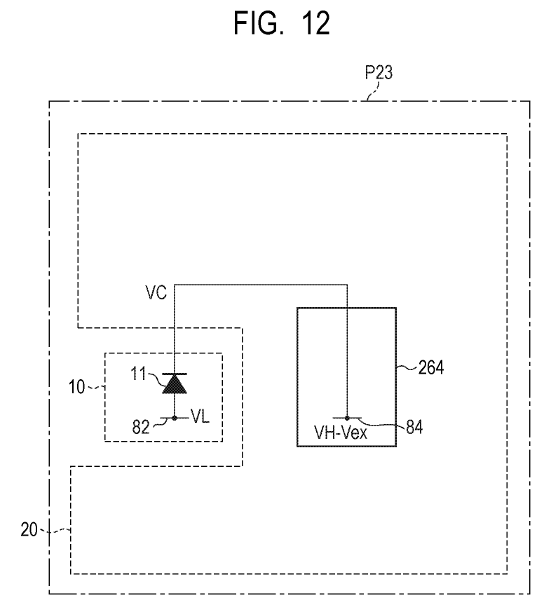

FIG. 12 is a block diagram of a dummy pixel P23 according to the present embodiment. The dummy pixel P23 has a voltage control circuit 264 and the same photoelectric conversion unit 10 as that of the active pixel P1.

The voltage control circuit 264 is a power supply interconnect 84 that supplies a reverse bias voltage. The reverse bias voltage of the power supply interconnect 84 is set to a voltage lower than the breakdown voltage Vbd, and is, for example, a voltage lower than the voltage VH by the excess voltage Vex. The power supply interconnect 84 is connected to the cathode of the APD 11.

When a photon is incident on the APD 11, the cathode voltage VC decreases due to the current of the APD 11. When the cathode voltage VC becomes lower than the reverse bias voltage of the power supply interconnect 84, a current flows from the power supply interconnect 84 to the cathode of the APD 11. It is possible to prevent the cathode voltage VC from falling beyond the reverse bias voltage of the power supply interconnect 84. As a result, the cathode voltage VC can be prevented from falling beyond the predetermined voltage.

### Fifth Embodiment

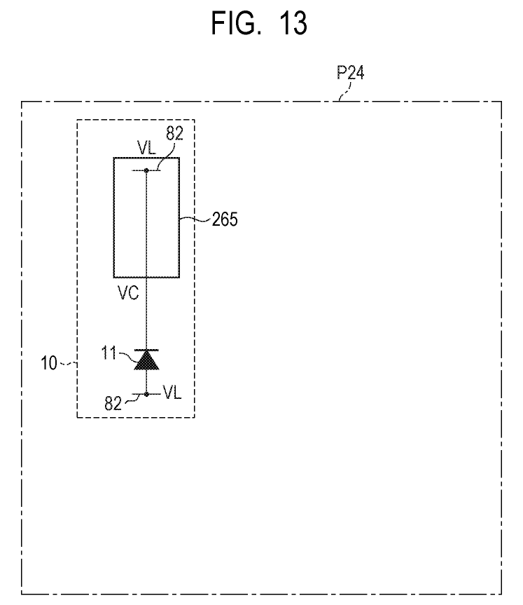

FIG. 13 is a block diagram of a dummy pixel P24 according to the present embodiment. The dummy pixel P24 has a voltage control circuit 265 and the same APD 11 as that of the active pixel P1.

The voltage control circuit 265 is a power supply interconnect 82 that supplies a reverse bias voltage. The power supply interconnect 82 is connected to the cathode and the anode of the APD 11. That is, the same voltage is supplied to the cathode and the anode of the APD 11. Accordingly, it is possible to suppress a current from flowing through the APD 11, and it is possible to suppress a decrease in the cathode voltage VC.

### Sixth Embodiment

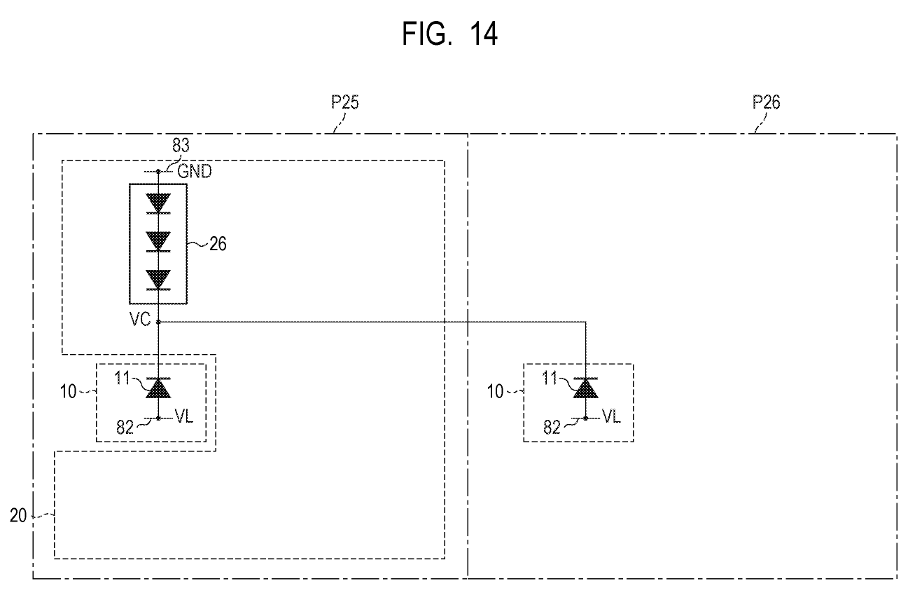

FIG. 14 is a block diagram of a first dummy pixel P25 and a second dummy pixel P26 according to the present embodiment. The first dummy pixel P25 has the same configuration as the dummy pixel P2 of FIG. 8. The second dummy pixel P26 does not include a voltage control circuit and includes only the photoelectric conversion unit 10. The first dummy pixel P25 and the second dummy pixel P26 share the voltage control circuit 26.

Specifically, the voltage control circuit 26 includes a first diode, a second diode, and a third diode, which are connected in series in this order. The cathode of the first diode is connected to the cathode of the APD 11 of the first dummy pixel P25 and the cathode of the APD 11 of the second dummy pixel P26. The anode of the third diode is connected to the power supply interconnect 83. Since the first dummy pixel P25 and the second dummy pixel P26 share the voltage control circuit 26, the layout area can be reduced.

### Seventh Embodiment

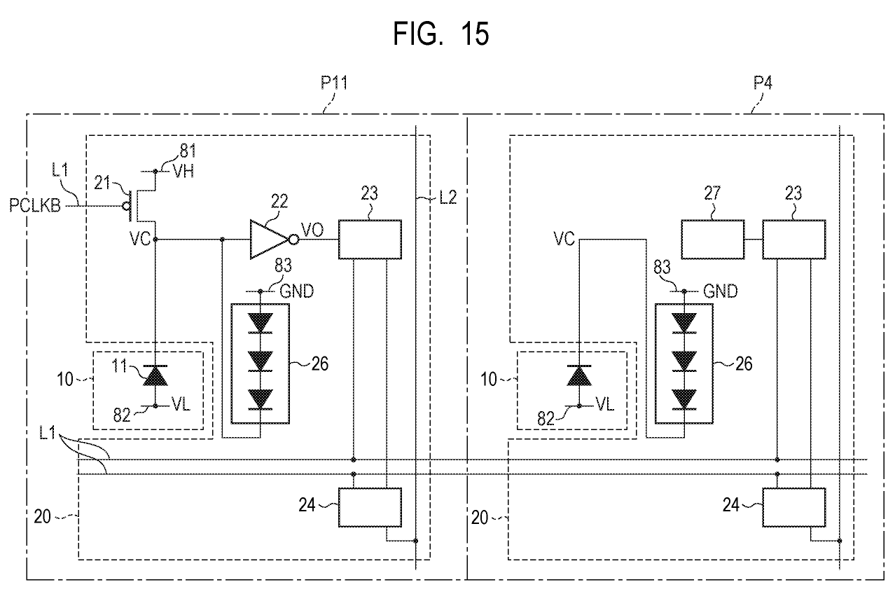

FIG. 15 is a block diagram of an active pixel P11 and a test pixel P4 according to the present embodiment. Like the dummy pixel P2, the active pixel P11 and the test pixel P4 each have a voltage control circuit 26. The test pixel P4 is arranged in place of some of the dummy pixels P2 in the third region A13 in FIG. 4. The test pixel P4 includes a photoelectric conversion unit 10 and a signal processing unit 20. The signal processing unit 20 includes a counter circuit 23, a selection circuit 24, a voltage control circuit 26, and a test circuit 27.

The counter circuit 23 and the selection circuit 24 of the test pixel P4 have the same configuration as the counter circuit 23 and the selection circuit 24 of the active pixel P11. The test pixel P4 tests the operations of the counter circuit 23 and the selection circuit 24. The counter circuit 23 and the selection circuit 24 are an example of a second signal processing circuit.

The test circuit 27 inputs a reference signal for an operational test to the counter circuit 23 and the selection circuit 24. For example, when the operation of the counter circuit 23 is tested, a predetermined number of pulse signals are input from the test circuit 27 to the LSB (the least significant bit) of the counter circuit 23, and it is confirmed that the count value read from the selection circuit 24 matches the predetermined number of pulses. Further, in order to test the operation of the selection circuit 24, the input from the vertical scanning circuit 30 to the selection circuit 24 is fixed to a high level or a low level, and it is confirmed that the value read from the selection circuit 24 matches the value fixed to the high level or the low level.

Since the test pixel P4 does not have the quench element 21 like the dummy pixel P2, the charge current is not supplied to the APD 11, and the reverse bias voltage capable of avalanche multiplication is not applied to the APD 11. Accordingly, the test pixel P4 can suppress the charge current and the avalanche current from flowing.

The cathode of the APD 11 is connected to the voltage control circuit 26. When a photon is incident on the APD 11, the cathode voltage VC decreases due to the current of the APD 11. When the cathode voltage VC falls to a predetermined voltage, the voltage control circuit 26 causes a current to flow from the power supply interconnect 83 to the cathode of the APD 11. As a result, the cathode voltage VC can be prevented from falling beyond the predetermined voltage.

### Eighth Embodiment

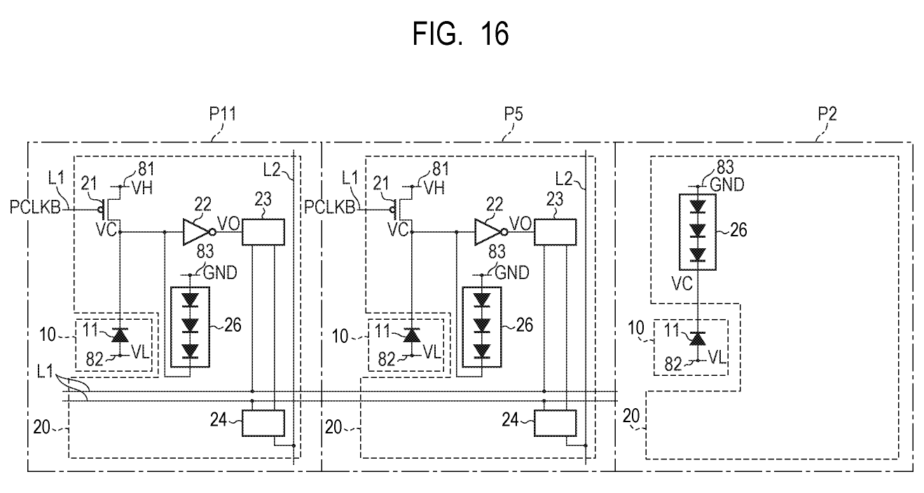

FIG. 16 is a block diagram of an active pixel P11, a dummy pixel P2, and an inactive pixel (third pixel) P5 according to the present embodiment. The active pixel P11 and the inactive pixel P5 in FIG. 16 have the same configuration as the active pixel P11 in FIG. 7. The dummy pixel P2 in FIG. 16 is configured in the same manner as the dummy pixel P2 in FIG. 8.

The inactive pixel P5 is, for example, a thinned-out pixel or a cropped pixel from which a pixel signal is not read. By reducing the number of pixels from which pixel signals are read out, the speed of reading out an image can be improved. Since the pixel signal of the inactive pixel P5 is not read, it is not necessary to avalanche-multiply the APD 11 of the inactive pixel P5. Therefore, the PMOS transistor of the quench element 21 maintains the off state, and the charge current is not supplied to the cathode of the APD 11. Thus, the inactive pixel P5 can suppress the charge current and the avalanche current.

The cathode of the APD 11 of the inactive pixel P5 is connected to the voltage control circuit 26. When a photon is incident on the APD 11, the cathode voltage VC decreases due to the current of the APD 11. When the cathode voltage VC falls to a predetermined voltage, the voltage control circuit 26 causes a current to flow from the power supply interconnect 83 to the cathode of the APD 11. As a result, the cathode voltage VC can be prevented from falling beyond the predetermined voltage, and the cathode voltage VC can be prevented from exceeding the withstand voltage of the PMOS transistor of the quench element 21.

### Ninth Embodiment

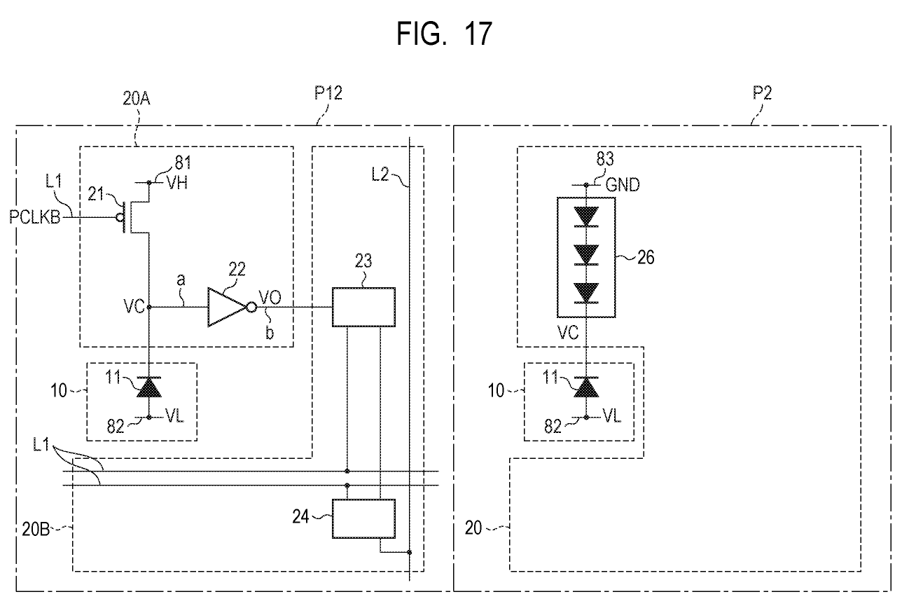

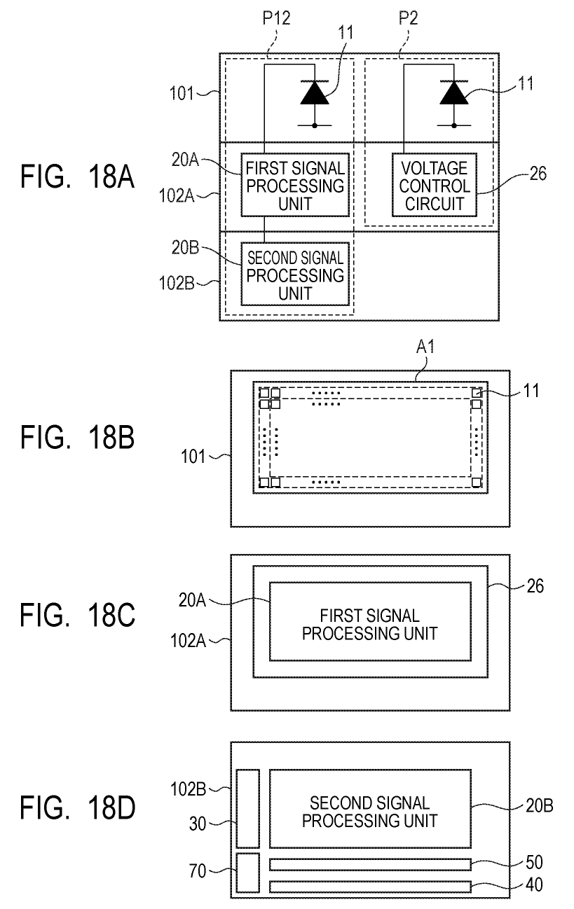

FIG. 17 is a block diagram of an active pixel P12 and a dummy pixel P2 according to the present embodiment. FIGS. 18A to 18D is a schematic diagram illustrating a configuration of a substrate according to the present embodiment, and FIG. 18A is a side view illustrating a configuration of a three-layer substrate. FIG. 18B is a plan view illustrating a configuration of a sensor substrate (first substrate) 101, FIG. 18C is a plan view illustrating a configuration of a first circuit substrate (second substrate) 102A, and FIG. 18D is a plan view illustrating a configuration of a second circuit substrate (third substrate) 102B.

The photoelectric conversion device 100 includes a sensor substrate 101, a first circuit substrate 102A, and a second circuit substrate 102B. The second circuit substrate 102B, the first circuit substrate 102A, and the sensor substrate 101 are stacked in this order. The APD 11 of the active pixel P12 and the APD 11 of the dummy pixel P2 are formed in the pixel region A1 of the sensor substrate 101. The first signal processing unit 20A of the active pixel P12 and the voltage control circuit 26 of the dummy pixel P2 are formed on the first circuit substrate 102A. The second signal processing unit 20B of the active pixel P12, the vertical scanning circuit 30, the readout circuit 40, the horizontal scanning circuit 50, and the control circuit 70 are formed on the second circuit substrate 102B. The first signal processing unit 20A is a part of the signal processing unit 20, and the second signal processing unit 20B is another part of the signal processing unit 20.

Thus, the first signal processing unit 20A and the second signal processing unit 20B are formed on different substrates. The power supply voltage of the first signal processing unit 20A and the power supply voltage of the second signal processing unit 20B may be different from each other. For example, the power supply voltage of the transistors of the first signal processing unit 20A (the quench element 21 and the waveform shaping circuit 22) may be higher than the power supply voltage of the transistors of the second signal processing unit 20B (the counter circuit 23 and the selection circuit 24). Specifically, the transistor of the first signal processing unit 20A is driven by a power supply voltage of 2.5 V, and the transistor of the second signal processing unit 20B is driven by a power supply voltage of 1.1 V. By changing the power supply voltages of the first signal processing unit 20A and the second signal processing unit 20B, it is possible to form circuits suitable for different circuit substrates.

### Tenth Embodiment

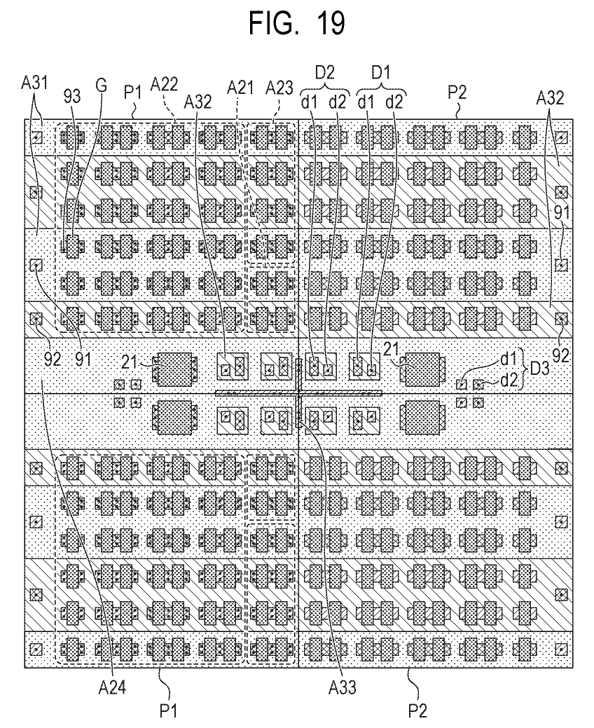

FIG. 19 is a plan view of a circuit substrate 102 according to the present embodiment. In FIG. 19, two active pixels P1 are illustrated on the left side, and two dummy pixels P2 are illustrated on the right side. The active pixel P1 has the circuit configuration of FIG. 7, and the dummy pixel P2 has the circuit configuration of FIG. 8.

The circuit region A2 is formed in the circuit substrate 102 of FIG. 1. The circuit region A2 includes an N-type well region A31 and a P-type well region A32. Each of the active pixel P1 and the dummy pixel P2 is formed in a common well region, and here, is formed in the N-type well region A31 and the P-type well region A32.

Each of the active pixel P1 and the dummy pixel P2 includes a first region A21, a second region A22, a third region A23, and a fourth region A24. A waveform shaping circuit 22 is formed in the first region A21, a counter circuit 23 is formed in the second region A22, a selection circuit 24 is formed in the third region A23, and a quench element 21, three diodes D1 to D3 constituting the voltage control circuit 26 are formed in the fourth region A24.

The PMOS transistor of the quench element 21 is formed in the N-type well region A31. The waveform shaping circuit 22 and the counter circuit 23 include PMOS transistors and NMOS transistors. The PMOS transistors of the waveform shaping circuit 22 and the counter circuit 23 are formed in the N-type well region A31. Each PMOS transistor includes a P-type active region and a gate electrode G. The diodes D1 to D3 include an N-type active region d1 and a P-type active region d2. The diode D3 is formed in the N-type well region A31. The PMOS transistor and the diode D3 of the quench element 21 share the N-type well region A31. In the active pixel P1 and the dummy pixel P2, an N-type well contact region 91 to which a predetermined voltage is applied is provided in the N-type well region A31.

The NMOS transistors of the waveform shaping circuit 22 and the counter circuit 23 are formed in the P-type well region A32. Each NMOS transistor includes an N-type active region and a gate electrode G. The diodes D1 and D2 are formed in the P-type well region A32. In the active pixel P1 and the dummy pixel P2, a P-type well contact region 92 to which a predetermined voltage is applied is provided in the P-type well region A32.

In the active pixel P1 and the dummy pixel P2, the quench element 21 and the diodes D1 to D3 are formed in the vicinity of adjacent pixels. The PMOS transistor of the quench element 21 is formed between two diodes D1 and D3 adjacent to each other in plan view. Among the diodes D1 to D3, the central diode D1 is preferably formed adjacent to the PMOS transistor of the quench element 21. Thus, the interconnect capacitance of the cathode of the diode D1 can be reduced, and power consumption can be reduced. Further, it is preferable that the diode D3 formed on the side opposite to the diode D1 at the center with respect to the PMOS transistor of the quench element 21 is connected to the power supply interconnect 83. Since the P-type substrate region can be shared with the peripheral transistors, the layout area can be reduced.

The transistor and the interconnect pattern of the dummy pixel P2 are configured in the same manner as the transistor and the interconnect pattern of the active pixel P1. In particular, since the interconnect pattern is similarly configured in the dummy pixel P2 and the active pixel P1, it is possible to suppress the transistor characteristics of the active pixel P1 adjacent to the dummy pixel P2 from significantly changing with respect to the transistor characteristics of the active pixel P1 not adjacent to the dummy pixel P2. Since the N-type well contact region 91 and the P-type well contact region 92 are provided in the dummy pixel P2 similarly to the active pixel P1, a change in the well voltage of the N-type well region A31 and the P-type well region A32 of the dummy pixel P2 is suppressed.

In the active pixel P1, transistors constituting the quench element 21, the waveform shaping circuit 22, the counter circuit 23, the selection circuit 24, and the voltage control circuit 26 are provided with contacts 93, and these transistors are connected to an interconnect pattern.

On the other hand, in the dummy pixel P2, the transistors constituting the quench element 21, the waveform shaping circuit 22, the counter circuit 23, and the selection circuit 24 are not provided with contacts, and these transistors are not connected to the interconnect pattern. Thus, in the dummy pixel P2, the quench element 21, the waveform shaping circuit 22, the counter circuit 23, and the selection circuit 24 are disabled. The diodes D1 to D3 constituting the voltage control circuit 26 are provided with contacts 93 and are connected to interconnect patterns.

### Eleventh Embodiment

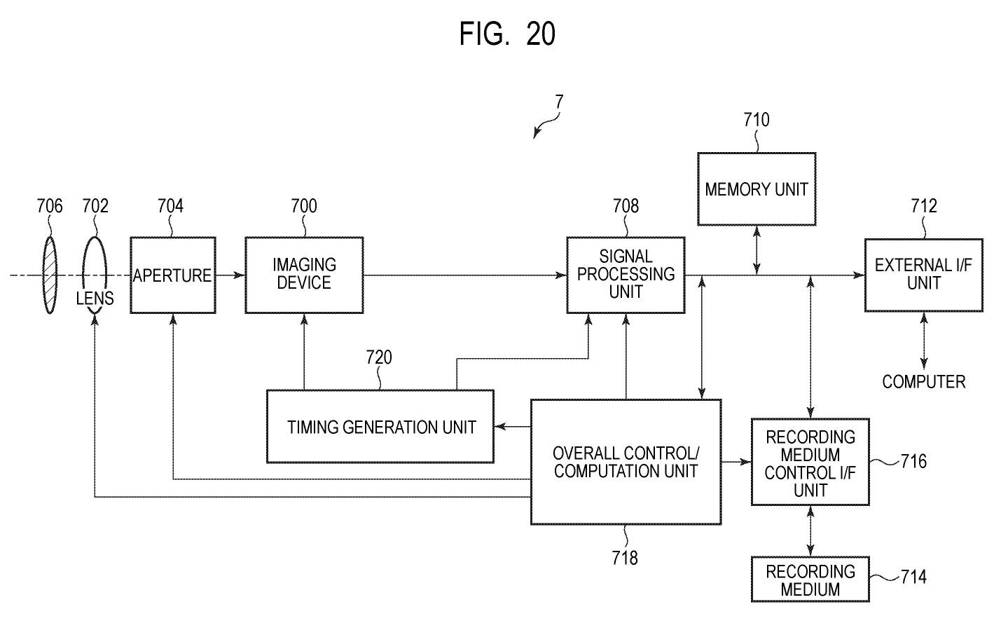

The photoelectric conversion device in the above-described embodiment can be applied to various devices. Examples of the device include a digital still camera, a digital camcorder, a camera head, a copier, a fax machine, a mobile phone, an in-vehicle camera, an observation satellite, and a monitoring camera. FIG. 20 is a block diagram of a digital still camera as an example of an apparatus.

The apparatus 7 illustrated in FIG. 20 includes a barrier 706, a lens 702, an aperture 704, and an imaging device 700 (an example of a photoelectric conversion device). The apparatus 7 further includes a signal processing unit (processing device) 708, a timing generation unit 720, an overall control/computation unit 718 (control device), a memory unit 710 (storage device), a recording medium control I/F unit 716, a recording medium 714, and an external I/F unit 712. At least one of the barrier 706, the lens 702, and the aperture 704 is an optical device corresponding to the imaging device 700. The barrier 706 protects the lens 702, and the lens 702 forms an optical image of an object on the imaging device 700. The aperture 704 makes the amount of light passing through the lens 702 variable. The imaging device 700 is configured as in the above-described embodiment, and converts an optical image formed by the lens 702 into image data (image signal). The signal processing unit 708 performs various corrections, data compression, and the like on the imaging data output from the imaging device 700. The timing generation unit 720 outputs various timing signals to the imaging device 700 and the signal processing unit 708. The overall control/computation unit 718 controls the entire digital still camera, and the memory unit 710 temporarily stores image data. The recording medium control I/F unit 716 is an interface for recording or reading image data on or from the recording medium 714, and the recording medium 714 is a detachable recording medium such as a semiconductor memory for recording or reading imaging data. The external I/F unit 712 is an interface for communicating with an external computer or the like. The timing signal and the like may be input from the outside of the apparatus 7. The apparatus 7 may further include a display device (a monitor, an electronic viewfinder, or the like) that displays information obtained by the imaging device 700. The apparatus 7 includes at least a photoelectric conversion device. Further, the apparatus 7 includes at least one of an optical device, a control device, a processing device, a display device, a storage device, and a mechanical device that operates based on information obtained by the photoelectric conversion device. The mechanical device is a movable unit (for example, a robot arm) that operates by receiving a signal of the photoelectric conversion device.

Each pixel may include a plurality of photoelectric conversion units (a first photoelectric conversion unit and a second photoelectric conversion unit). The signal processing unit 708 may be configured to process the pixel signal based on the charge generated in the first photoelectric conversion unit and the pixel signal based on the charge generated in the second photoelectric conversion unit and acquire the distance information from the imaging device 700 to the object.

### Twelfth Embodiment

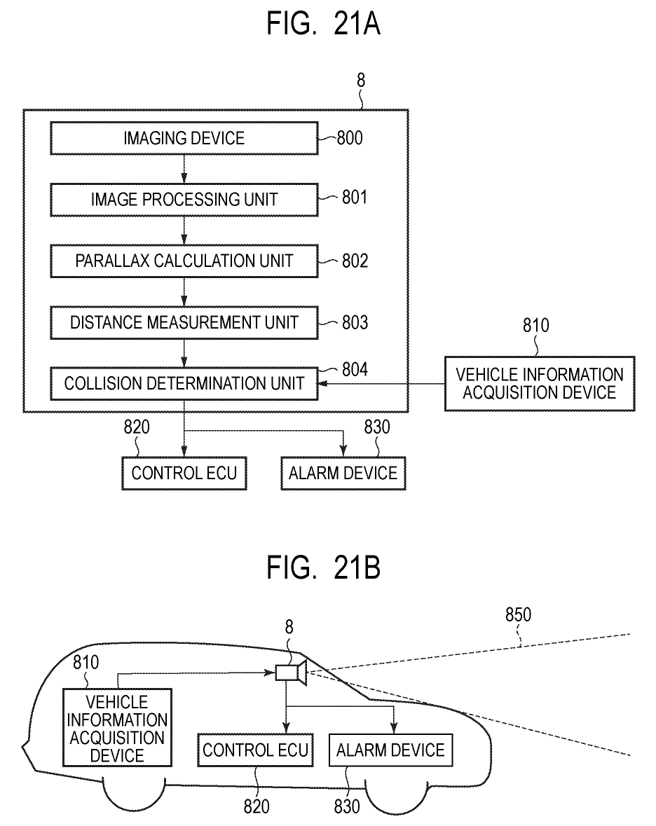

FIGS. 21A and 21B are block diagrams of an equipment 8 related to an in-vehicle camera according to the present embodiment. The equipment 8 includes an imaging device 800 (an example of a photoelectric conversion device) and a signal processing device that processes a signal from the imaging device 800. The equipment 8 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 8. In addition, the equipment 8 includes a distance measurement unit 803 that calculates a distance to the object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information related to a parallax, a defocus amount, a distance to the object, and the like. The collision determination unit 804 may determine the collision possibility using any of these pieces of distance information. The distance information acquisition unit may be realized by dedicatedly designed hardware or may be realized by a software module. Also, it may be realized by FPGA (Field Programmable Gate Array), ASIC (Application Specific Integrated Circuit) or a combination thereof.

The equipment 8 is connected to the vehicle information acquisition device 810 and can acquire vehicle information such as a vehicle speed, a yaw rate, and a steering angle. In addition, a control ECU 820, which is a control device that outputs a control signal for generating a braking force to the vehicle based on the determination result of the collision determination unit 804, is connected to the equipment 8. The equipment 8 is also connected to an alarm device 830 that issues an alarm to the driver based on the determination result of the collision determination unit 804. For example, when the determination result of the collision determination unit 804 indicates that the possibility of collision is high, the control ECU 820 performs vehicle control to avoid collision and reduce damage by, for example, applying a brake, returning an accelerator, or suppressing engine output. The alarm device 830 gives an alarm to the user by sounding a warning such as a sound, displaying warning information on a screen of a car navigation system or the like, giving vibration to a seat belt or a steering wheel, or the like. The equipment 8 functions as a control unit that controls the operation of controlling the vehicle as described above.

In the present embodiment, the surroundings of the vehicle, for example, the front or the rear are imaged by the equipment 8. FIG. 21B illustrates an equipment in a case of capturing an image in front of the vehicle (imaging range 850). The vehicle information acquisition device 810 serving as the imaging control unit sends an instruction to the equipment 8 or the imaging device 800 to perform the imaging operation. With such a configuration, the accuracy of distance measurement can be further improved.

In the above description, an example in which control is performed so as not to collide with another vehicle has been described, but the present disclosure is also applicable to control in which automatic driving is performed so as to follow another vehicle, control in which automatic driving is performed so as not to protrude from a lane, and the like. Further, the equipment 8 is not limited to a vehicle such as an automobile, and can be applied to, for example, a ship, an aircraft, an artificial satellite, an industrial robot, a consumer robot, or a similar mobile object (mobile device). In addition, the present disclosure is not limited to a mobile object and can be widely applied to devices utilizing object recognition or biological recognition, such as an intelligent traffic system (ITS) and a monitoring system.

### Modified Embodiments

The present disclosure is not limited to the above embodiment, and various modifications are possible. For example, an example in which a partial configuration of one embodiment is added to another embodiment or an example in which a partial configuration of one embodiment is replaced with a partial configuration of another embodiment is also an embodiment of the present disclosure.

For example, the voltage control circuit 26 controls the voltage of the cathode of the APD 11, but is not limited thereto, and may control the voltage of the anode of the APD 11.

In addition, although the configuration using the counter circuit 23 is illustrated, the present disclosure is not limited to this, and a photoelectric conversion device that acquires pulse detection timing using a time-to-digital conversion circuit (Time-to-Digital Converter: TDC) and a memory may be used. At this time, the generation timing of the pulse signal output from the waveform shaping circuit 22 is converted into a digital signal by the TDC. A control signal is supplied to the TDC from the vertical scanning circuit 30 via the control line L1 in order to measure the timing of the pulse signal. The TDC acquires, as a digital signal, a signal when an input timing of a signal output from each pixel via the waveform shaping circuit 22 is set to a relative time with reference to the control signal.

According to the present disclosure, it is possible to realize a photoelectric conversion device capable of suppressing a current in a pixel that does not output a signal by an APD.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-043653, filed Mar. 18, 2025, which is hereby incorporated by reference herein in its entirety.

What is claimed is:

1. A photoelectric conversion device comprising:
a first pixel including a first avalanche photodiode and a charge circuit configured to apply a first reverse bias voltage equal to or higher than a breakdown voltage to the first avalanche photodiode, wherein the first pixel is configured to output a signal by avalanche multiplication of the first avalanche photodiode; and
a second pixel including a second avalanche photodiode and a voltage control circuit configured to apply a second reverse bias voltage lower than the breakdown voltage to the second avalanche photodiode, wherein the second pixel is configured not to output a signal by avalanche multiplication of the second avalanche photodiode,
wherein the voltage control circuit is configured to control the second reverse bias voltage applied to a cathode of the second avalanche photodiode based on a voltage of the cathode.

2. The photoelectric conversion device according to claim 1, wherein the voltage control circuit is configured to control the second reverse bias voltage so that the voltage of the cathode does not become equal to or lower than a predetermined voltage.

3. The photoelectric conversion device according to claim 1, wherein the first pixel includes another voltage control circuit configured to apply the second reverse bias voltage to the first avalanche photodiode.

4. The photoelectric conversion device according to claim 1,
wherein the voltage control circuit includes a diode,
wherein a power supply voltage lower than the breakdown voltage is applied to an anode of the diode, and
wherein a cathode of the diode is connected to the cathode of the second avalanche photodiode.

5. The photoelectric conversion device according to claim 4, wherein the voltage control circuit includes a plurality of the diodes connected in series.

6. The photoelectric conversion device according to claim 1,
wherein the voltage control circuit includes a transistor,
wherein a power supply voltage lower than the breakdown voltage is applied to a first main node of the transistor, and
wherein a second main node and a control node of the transistor are connected to the cathode of the second avalanche photodiode.

7. The photoelectric conversion device according to claim 1,
wherein the voltage control circuit includes a diode and a transistor,
wherein a power supply voltage lower than the breakdown voltage is applied to an anode of the diode,
wherein a cathode of the diode is connected to a first main node of the transistor, and
wherein a second main node and a control node of the transistor are connected to the cathode of the second avalanche photodiode.

8. The photoelectric conversion device according to claim 1, wherein the voltage control circuit is a power supply interconnect for supplying the second reverse bias voltage.

9. The photoelectric conversion device according to claim 8, wherein the power supply interconnect is connected to an anode and the cathode of the second avalanche photodiode.

10. The photoelectric conversion device according to claim 8, wherein the power supply interconnect is connected to an anode of the first avalanche photodiode.

11. The photoelectric conversion device according to claim 1, wherein a plurality of second pixels share the voltage control circuit.

12. The photoelectric conversion device according to claim 1, further comprising a third pixel having the same configuration as the first pixel,
wherein the charge circuit of the third pixel is configured to maintain an off state.

13. The photoelectric conversion device according to claim 12, wherein the third pixel includes another voltage control circuit configured to apply the second reverse bias voltage to an avalanche photodiode of the third pixel.

14. The photoelectric conversion device according to claim 1,
wherein the first pixel includes a first signal processing circuit configured to process a signal from the first avalanche photodiode, and
wherein the second pixel includes a second signal processing circuit including the same configuration as the first signal processing circuit, and a test circuit configured to input a reference signal for an operational test of the second signal processing circuit to the second signal processing circuit.

15. The photoelectric conversion device according to claim 1, further comprising a substrate on which the first pixel and the second pixel are arranged,
wherein the substrate includes:
a first substrate on which the first avalanche photodiode and the second avalanche photodiode are arranged;
a second substrate stacked on the first substrate, on which a part of a first signal processing circuit configured to process a signal from the first avalanche photodiode and the voltage control circuit are arranged; and
a third substrate stacked on the second substrate, on which another part of the first signal processing circuit is arranged.

16. The photoelectric conversion device according to claim 1,
wherein the first pixel and the second pixel are arranged in a common well region, and
wherein a plurality of transistors and a plurality of interconnect patterns included in the first pixel have the same configuration as a plurality of transistors and a plurality of interconnect patterns included in the second pixel.

17. The photoelectric conversion device according to claim 16,
wherein the first pixel includes a first signal processing circuit configured to process a signal from the first avalanche photodiode, and
wherein among the plurality of transistors included in the second pixel, transistors corresponding to the charge circuit and the first signal processing circuit are not connected to the interconnect patterns.

18. The photoelectric conversion device according to claim 16,
wherein the voltage control circuit includes a plurality of diodes connected in series, and
wherein the transistor constituting the charge circuit is arranged between two adjacent diodes in plan view.

19. The photoelectric conversion device according to claim 16, wherein the well region in which the second pixel is arranged includes a contact to which a predetermined voltage is applied.

20. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.
